(19) United States
(12) Patent Application Publication
(10) Pub. No.: US 2002/0198933 A1
(43) Pub. Date: Dec. 26, 2002

(54) Method of lowering labor and marketing cost of a commercial website

(76) Inventor: Dusic Kwak, Annandale, VA (US)

Correspondence Address: Dusic Kwak, 7003- B Evergreen Court, Annandale, VA, 22003, US

(21) Appl. No.: 09/883,934

(22) Filed: Jun. 20, 2001

(51) Int. Cl. G06F 15/16

(52) U.S. Cl. 709/203

(57) ABSTRACT

A method for lowering labor and marketing cost for a commercial website through cost-effectively acquiring website traffic and website content data through providing an incentives package, which is precursor to a professional commercial website, to a plurality of target groups in specifically chosen communities: An ASP/WSP identifies as many types of qualified communities as possible; selects one type of qualified community, which meets the predefined requirements; determines what type of commercial website is needed by the selected type of qualified community; prepares a template website application for the selected type of qualified community; prepares CWAWIP by combining template website application with web-hosting service and a permission to grant all future revenue to be generated by mid-sized commercial websites to the corresponding POG; identifies and makes a list of all selected types of QCs in a nation; selects a QC according to the order of the list; identifies and makes a list of POGs in the selected QC; selects a POG according to the order of the list; offers CWAWIP to the selected POG, conditioned on POG's granting a license to the ASP/WSP to freely use website traffic and website content data to be generated in the mid-sized commercial websites of POGs; if license is granted, ASP/WSP provides CWAWIP to the POG; assists POG in setting up and running a mid-sized commercial website; selects more POGs to offer CWAWIP, to assist the set-up and running of mid-sized commercial websites for these POGs, and receives licenses until the last QC on the list is reached; and finally prepares a consolidated commercial website, which uses all website traffic and website content data gather under said license.

### BACKGROUND OF THE INVENTION

1. Field of the Invention

The present invention is directed to a method of lowering labor and marketing cost of a commercial website.

2. Terminology Used in This Application Defined

Terminology as used in this description and in claims are defined as follows:

“ASP” is an acronym for Application Service Provider.

“ASP/WSP” denotes an entity, which is both an ASP and a WSP. It provides a combined services of website application and web-hosting. Website application and web-hosting combines to form an e-commerce system.

“Banner display” denotes the displaying of a company banner on a website for advertising where the banner is hypertext-linked to the website of advertising party.

“B-to-B Internet Business Model” denotes a business model on Internet where goods or services of one commercial entity are sold to another commercial entity in order to enable the buyer entity to sell goods or services to individual consumers.

“B-to-C Internet Business Model” denotes a business model on Internet where goods or services of a commercial entity are sold to individual consumers directly.

“Commercial website” denotes a website that is primarily commercial in nature, such as search engines I directory, classified sites, auction sites, or Internet stores and often containing complicated programmed functions to perform designated commercial functions. Commercial websites are distinguished from personal and corporate image websites.

“Consolidated commercial website” denotes a commercial website containing the consolidated website traffic and website content data of mid-sized commercial websites.

“Cost-free website application and web-hosting incentives package (CWAWIP)” denotes an incentives package comprising of website application and web-hosting service provided by ASP/WSP either entirely free of charge or at a very small fee (to be paid after generation of revenue from the operation of an e-commerce system). CWAWIP also includes a permission by the ASP to a POG to keep all revenue expected to be generated from the operation of its own mid-sized commercial website.

“E-commerce system” denotes a complete system of commercial website constructed from CWAWIP. In particular, an e-commerce system contains a website application and web-hosting service provided by an ASP/WSP in the CWAWIP.

“Internet” is synonymously used with World Wide Web.

“Mid-sized commercial website” denotes a commercial website operating within a qualified community by a potential operator group.

“Mid-sized market” denotes an online market for goods and services created in qualified communities.

“Potential operator group (POG)” denotes a commercial or noncommercial group in a qualified community, economically situated to accept a CWAWIP, staffed with volunteers or low-cost personnel to operate a mid-sized commercial website in the qualified community at little or no labor and marketing cost, and possesses an established communication channel with constituents of qualified community. There can be more than one POG within a given qualified community. Some examples of POGs are college student association, college newspaper, college fraternity or sorority house, or a club in a college campus community; and ethnic associations in cities presiding over a population of localized ethnic population; national or localized clubs presiding over its population of members.

“Primary market” is used synonymously with “mid-sized market”.

“Qualified Community (QC)” denotes a physical community, ranging between 1,000 and 100,000 in population, which has at least on POG and which operates culturally, economically and/or geographically as a single unit. Communities, such as college campus, college campus town, social club (e.g., Rotary Club, Lions Club), and local ethnic associations, are examples of qualified communities.

“Web-hosting service” denotes a service provided by WSP consisting of hosting of websites on the WSP's server, Internet line usage, and program (application) maintenance.

“Website application” denotes the entire pre-programmed part of a commercial website software, containing programs or routines to perform designated functions. Website application commonly excludes the editable HTML inputs updated by users (or by webmaster) as needed.

“Website content data” is synonymous with “website content material” and denotes entire non-program part of Internet website, which users or webmaster inputs into the database for the website or edits to be displayed to other Internet users; Website content material is updated with comparative ease.

“Website traffic” denotes the total incidences of website usage at a given time by users of a website; Website traffic is directly proportional to registered membership of a website.

“User” denotes both registered and non-registered visitor of a website.

“WSP” is an acronym of Web-hosting Service Provider.

3. Related Art

Internet websites have become increasingly popular and commonplace. Despite the recent decline of technology stocks in the NASDAQ market, literally millions upon millions of commercial and noncommercial websites still operate on the Internet, often without reaping any significant economical benefits. Most websites require a sizable website traffic to profitably operate, and it costs marketing dollars to gain a significant website traffic. Furthermore, a continuing labor cost is incurred to prepare a professional website and to subsequently maintain and update content material of a website. Commercial websites operating in a B-to-B or B-to-C business model, in particular, where goods and services of a business are primarily sold to other businesses or to consumers, respectively, have suffered financially the most from Internet's inherent irreconcilable characteristics of high labor and marketing costs vis-a-vis low revenue generation.

There basically exist three different types of websites—personal home-pages, corporate image websites, and commercial websites. Of the three, commercial websites shall constitute the proper object of present invention, although present invention applies equally well to personal home-pages and corporate image websites as well; and search engines, directories, classified sites, auction sites, or Internet stores shall together be referred to as “commercial websites”.

In a B-to-B Internet business model, a commercial website often provides goods transaction services—such as auction or classified service-to enable users to sell, buy, or broker products between and amongst themselves. The main source of revenue for such a commercial website is item listing service and banner advertising service. However, this type of revenue generation model of B-to-B system does not always return a positive net profit for a commercial website. Such is partly due to the widespread notion that Internet should be kept free of charge and partly due to the high labor cost associated with the preparation of website content material and subsequent marketing (i.e., advertisement) of the website. Combined cost of marketing and labor for website content preparation comprise one of the largest expenditure factor for any commercial website. Therefore, as long as revenue generation of a commercial website in the B-to-B Internet business model does not improve and/or costs of labor and marketing decrease, the profit margin for a commercial website will always remain in the negative or small. Commercial websites up to this point has not and could not deal with this structural imbalance.

A similar statement may be made for a commercial website in a B-to-C business model, wherein goods or services are sold directly to individual consumers. A commercial website in a B-to-C Internet business model similarly suffers from high labor and marketing cost in creating a professional looking website and to conduct a marketing campaign to advertise to the public of its goods or services. With possible exception of some websites, such as those selling pornography, revenue generated by most of such “retail” websites are insufficient to return a profit.

The following analogy may be useful in further illustrating current structural profitability problem of B-to-B or B-to-C business models: Internet is a vast “Pacific Ocean” in terms of number of websites, and a commercial website operating within it is just a small uncharted island, whose location the world is either unaware of or does not have a cause to particularly care about. Without proper marketing, a commercial website just cannot spontaneously present itself to Internet users and will continue to go unnoticed unless something is done to advertise itself to Internet users. Also, without maintaining a professional appearance by constant updating, a commercial website will quickly lose any visitors to the website. Hence, marketing and labor cost for up-keeping of a website is a prerequisite cost, not an extra expense.

The recent collapse of NASDAQ market proved the existence of intrinsic shortcomings of B-to-B and B-to-C business models. Contrary to popular expectations, most Internet companies listed on NASDAQ did not show positive profit when annual financial statements were published for fiscal year 2000. Indeed, many reported unchanging or weak annual revenues despite high labor and marketing cost expended. It is evident, therefore, that a different Internet method or business model is needed, which minimizes such labor and marketing cost and maximizes revenue generation at the same time.

The traditional website content preparation method is too cost-ineffective. Most commercial website companies either have to hire a high-salaried, computer-savvy webmaster or specialists to research and update content for an existing commercial website. Maintenance of a commercial website becomes more costly as the size of a commercial website increases or topics of the website become more technical and involved. Yet, a professional-looking, content-filled commercial website is just a prerequisite to attracting visitors and not a guarantee that visitors will come in. On the contrary, an unprofessional, late-to-update, information-lacking commercial website will certainly fail to retain visitors to the website. Therefore, spending high dollars on website content preparation will not necessarily proportionally increase the website traffic or revenue.

The traditional advertising (i.e., marketing) methods for a commercial website in a B-to-B or B-to-C business model usually are also cost-ineffective. Traditional website advertising methods involve one or more of the following: 1. Registering with search engines or 2. directories; 3. displaying company banner on other websites; 4. mutual linking with other relevant websites; 5. advertising in radio, television, newspaper, or periodicals; 6. submitting URL (Universal Resource Locator) to search engines/directories to be included in search results of search engines and be listed in the directories; 7. mass e-mailing to selected e-mail holders (which is called “spamming”, and is illegal or unethical); or 8. direct interaction with existing clientele. With the possible exception of banner display (especially on Yahoo or other major sites) and advertising in radio, television, newspaper, or periodicals, all other enumerated methods are simply ineffective to work up a significant website traffic. Further, banner display in Yahoo or other major sites and advertising in radio, television, newspaper, or periodicals are too costly for the level of advertising result they bring. Hence, none of the traditional advertisement methods will cost-effectively promote a commercial website.

Some industry insiders appeared to have recognized the cost-ineffectiveness of traditional advertising methods and attempted to mend it by forming consolidated websites. That is, recognizing that increased website traffic decreases marketing cost and is ultimately proportional to revenue generation, some Internet giants, such as Yahoo and Microsoft, appeared to have attempted to increase website traffic by consolidating sub-markets created by smaller individual commercial websites hosted in their respective main websites. In particular, by providing to other businesses a website application combined with web-hosting for a charge, in the form of pre-made commercial sub-websites amounting to a store of some kind within their parent website, Yahoo and Microsoft (i.e., http://www.bCentral.com) appeared to have attempted to allow individual sub-websites to collect their own users within these sub-websites. Yahoo and Microsoft would then re-channel such traffic toward their respective main sites. However, it is worth noting that commercial entities are drawn to Yahoo or Microsoft for the prospect of sharing Yahoo's established website traffic in the first place, not to create new website traffic on their own. And, indeed, the sub-websites of Yahoo and Microsoft do not have noticeable power to attract website traffic on their own, aside from the website traffic already gathered and provided by Yahoo and Microsoft.

Some, such as Insidecollege.com (http://www.insidecollege.com), display a different approach to the consolidation of sub-markets: They attempted to increase website traffic by consolidating pre-existing commercial websites of college newspaper organizations by providing free modular website solution software to such entities in exchange for and as an incentive to form a loose affiliation between Insidecollege.com and college newspaper's commercial websites. Upon acceptance, Insidecollege.com's modular website solution software (e.g., auction solution software) is incorporated into pre-existing commercial websites of college newspapers by linking, and, in return, the college newspapers share their pre-existing website traffic (by allowing free banner display or the like) with Insidecollege.com. However, Insidecollege.com, like many other websites which utilize free computer/Internet software solutions as incentives for formation of commercial affiliation, appears to be only marginally successful in benefiting from website traffic generated by its recipient college newspaper websites. Insidecollege.com, has not been able to achieve a large-scale unification of sub-markets of all its affiliated college newspaper websites, because provision of modular website solution software, in and of itself, is not a sufficient incentive to recruit a large number of college newspapers websites.

Some, such as Labx.com (http://www.labx.com), have attempted to increase website traffic by preparing complete commercial website templates (which they sell to their customers for a one-time price) coupled with occasional hosting of the resulting commercial websites on their server (for a price as well). Labx.com is different from Yahoo or Microsoft in that it sells its commercial website templates and does not always host sub-websites on its server. Labx.com's targets for website traffic consolidation comprise largely of its pre-existing customers who list classified ads and auction listings on Labx.com. Labx.com first sells website application templates to such customers and then forms a loose business affiliation with them, often obtaining free banner display spots on these targets' websites. In entirety, Labx.com also has not achieved a significant consolidation of website traffic of their affiliated customers' commercial websites, because the sub-markets created by commercial websites of individual goods vendors had negligible individual website traffic.

In summary, all prior efforts listed supra have failed at successfully acquiring significant additional website traffic. What is needed, then, is a more efficient method to acquire website traffic (and website content data, in addition), thereby minimizing marketing and labor cost. Acquisition of a large website traffic would obviate or at least lower expenses necessary to advertise a website, and acquisition of a large volume of website content data would reduce labor cost required for a commercial website to maintain its website content.

An efficient method for lowering labor and marketing cost of a commercial website through cost-effectively acquiring website traffic and website content material, as disclosed in the present invention, involves the following sequential steps: An ASP/WSP identifies as many types of qualified communities as possible; selects one type of qualified community, which meets the predefined requirements; determines what type of commercial website is needed by the selected type of qualified community; prepares a template website application for the selected type of qualified community; prepares CWAWIP by combining template website application with web-hosting service and a permission to grant all future revenue to be generated by mid-sized commercial websites to the corresponding POG; identifies and makes a list of all selected types of QCs in a nation; selects a QC according to the order of the list; identifies and makes a list of POGs in the selected QC; selects a POG according to the order of the list; offers CWAWIP to the selected POG, conditioned on POG's granting a license to the ASP/WSP to freely use website traffic and website content data to be generated in the mid-sized commercial websites of POGs; if license is granted, ASP/WSP provides CWAWIP to the POG; assists POG in setting up and running a mid-sized commercial website; selects more POGs to offer CWAWIP, to assist the set-up and running of mid-sized commercial websites for these POGs, and receives licenses until the last QC on the list is reached; and finally prepares a consolidated commercial website, which uses all website traffic and website content data gather under said license.

A POG is specifically defined to be a group within a qualified community that has a volunteer staff, an established communication channel, and economically-situated to easily accept CWAWIP. A qualified community is defined to be a physical community, ranging between 1,000 and 1000,000 in population, which operates economically, culturally, and/or geographically as a single unit. Theoretically, there can be more than one qualified community in one geographical area and more than one POG within each qualified community.

POGs are ideal in running mid-sized commercial websites because they come with pre-existing ability to supply marketing and labor for free or at a very low cost. A POG is induced to run a mid-sized commercial website by an unmistakably attractive incentives package, which allows them not to expend any money on setting up, running, and maintaining a professional commercial website and no subsequent obligation to pay royalties for the use of the website. A POG is additionally promised that it can retain all future revenue to be generated within its own particular mid-sized commercial website. A POG needs to bring only minimal technical ability to provide content material to their commercial website. While the ASP/WSP bears the entire cost associated with running a professional commercial website, the POGs bear a huge portion of marketing and labor required to obtain appropriate level of website traffic and website content material for mid-sized commercial websites. A POG, however, only need to use its volunteer manpower to achieve these purposes. Thus, the POGs are extending to the ASP/WSP its marketing structure already in place and the labor needed to prepare website content material, and advertising and labor cost that was originally needed to obtain website traffic and website content material corresponding to a particular qualified community is minimized.

Revenue generation for both mid-sized commercial websites (belongs to POGs) and consolidated commercial websites (belongs to ASP/WSP) are maximized as well. The present invention presents a win-win model because both the ASP/WSP and qualified communities barter what they already have (or can provide at very low cost) in exchange for what they need in order to generate revenue in their respective commercial websites. Importantly, the cost of such barter is low for both parties, and extra value is created out of some aspect of their beings, which each can spare to the other either at no cost or at a comparatively low cost.

Although there are no known prior arts in the form of issued or pending patents that describe a method disclosed in the present invention, there are five traditional methods—three of which were discussed briefly supra—that are similar to the website traffic (website content data not included) acquisition method disclosed in the present invention.

The first method involves mutual linking between websites to increase website traffic. Many websites commonly promote their websites by mutually linking their websites with another through hypertext insertions within their websites. The result is that users of a link-hosting site are introduced to the linked site in a limited way.

The second method involves exchange of banners. Exchange of banners is commonplace and is similar to hypertext linking in the way it operates and in its effectiveness.

The third method involves selling pre-made complete website software to other commercial entities (such as customers) and receiving banner display or linking in return. The seller of a pre-made, complete website software is an ASP who links their own banner on a website it produced for free or for a consideration. An illustration of this method is found with Labx.com.

The fourth method involves making and distributing pre-made commercial websites amounting to a store of some kind within a well-known parent website to gain website traffic generated by such pre-made commercial websites. An illustration of this method is found with Yahoo and Microsoft.

The fifth method involves distributing pre-made modular website solutions (such as an auction module) free to other entities which need these functions incorporated into their pre-existing websites. The provider of the module software often receives advertising opportunities from the recipients in consideration for receiving free software.

The first and second methods are distinguished easily from the method of present invention in that no pre-made website is involved.

The third and fourth methods are distinguished from the method of present invention in that pre-made websites are provided to other commercial entities, not to POGs. Commercial entities do not necessarily have inherent constituents/membership like the qualified communities governed by POGs, which can be readily converted into website traffic. Commercial entities have, at best, limited ability to generate large membership by promoting their own websites.

Yet another distinction between the third and fourth methods in relation to the method as disclosed in the present invention involves the magnitude of incentives offered. The present invention discloses an incentives package consisting of free, complete, and combined package of website application, web hosting, and a permission to keep all resulting revenue, unlike the mere website templates of Yahoo, Microsoft, and Labx.com, which are either sold or hosted at a cost.

The fifth method is distinguished from the method disclosed in the present invention in that Insidecolleges.com offers only a website solution module program as incentive, as contrasted by a complete e-commerce system offered by ASP/WSP in the present invention. While Insidecolleges.com also provides its incentive package to a seeming POG (i.e., the college newspaper), the incentive package of a website solution module is too small to allow a POG to readily agree to share the website content material and website traffic. In addition, the incentive of website solution module (e.g., auction solution module) involves the obvious technical obstacle of incorporating the module into pre-existing website of college newspapers—not an insignificant feat. Furthermore, the monetary savings represented by a free website solution module is marginal and requires that a POG already have a website operating. Obviously, not all POGs have pre-existing commercial websites, thus the extent to which Insidecolleges.com would be able to consolidate their targets was limited in scope.

The method disclosed in the present invention, on the other hand, is not affected by the absence of pre-existing commercial website, as CWAWIP itself gives rise to a commercial website.

### 4. SUMMARY OF INVENTION

This novel and unobvious invention satisfies the needs for a more efficient method to lower labor and marketing cost of a commercial website by acquiring website content data and website traffic from a plurality of smaller commercial websites.

A preferred version of the method for lowering labor and marketing cost of a commercial website of the present invention comprises following steps:

(a) identifying types of qualified communities, which ranges between 1,000 and 100,000 in population, has at least one POG, and operates culturally, economically and/or geographically as a single unit;

(b) selecting a type of qualified community from said types of qualified communities;

(c) determining what type of commercial website is needed by said selected type of qualified community;

(d) preparing a template website application in accordance with said determination;

(e) preparing an incentives package comprising of template website application, subsequent web-hosting service, and a permission to potential operator group to keep all revenue generated by operation of a mid-sized commercial website, to be built from and operated with said incentives package;

(f) identifying and making a list of all selected type of qualified communities in a nation;

(g) selecting a qualified community according to the order of the said list;

(h) identifying and making a list of all potential operator groups in said qualified community, which are economically situated to accept a cost-free website application and web-hosting incentives package, staffed with volunteers or low-cost personnel to operate a mid-sized commercial website in the qualified community at little or no labor and marketing cost, and possesses an established communication channel with constituents of qualified community;

(i) selecting a potential operator group according to the order of said list;

(j) offering said incentives package cost-free to said potential operator group, conditioned upon said potential operator group's granting of a license to an ASP/WSP to freely use website traffic and website content data to be generated in said mid-sized commercial website of a potential operator group;

(k) receiving said license, if said potential operator group grants said license; or select another potential operator group by repeating steps (i),

(j), and (k), if said potential operator group rejects granting of said license;

(l) providing said incentives package cost free to said potential operator group,

(m) assisting said potential operator group in setting up and running a mid-sized commercial website to be derived from said incentives package;

(n) repeating steps (g), (h), (i), (j), (k), (l) and (m) until last qualified community on said list of all selected type of qualified communities has been offered a CWAWIP; and

(o) preparing a consolidated commercial website, which uses all website traffic and website content data gathered from all of said mid-sized commercial websites.

Further embodiments of the present invention involves providing said incentives package cost-free to said potential operator group, conditioned on said potential operator group's granting of a license to the ASP/WSP to use database of potential operator group's registered membership without fee.

Essential features of present invention are as follows: First, the present invention targets only POGs, which by definition has volunteer or low cost manpower, as recipients for CWAWIP. Other individuals or entities are excluded in the present invention as targets of providing CWAWIP. Since, CWAWIP involves a significant expense on the part of an ASP/WSP, in terms of website application development and anticipated web-hosting expenses, a recipient of CWAWIP must be situated to cost-effectively acquire website traffic in its corresponding qualified community for its mid-sized commercial website and must also be situated to cost-effectively enter and edit the editable parts of its own mid-sized commercial website (i.e., website content data). That way, such savings in cost of labor and marketing trickles down to the ASP/WSP. Hence, cost-effective marketing and labor for a mid-sized commercial website, and ultimately for a consolidated commercial website, is made possible only through selecting a POG to operate a mid-sized commercial website for its corresponding qualified community.

The best example of a POG is a college student association governing its student body (a qualified community). A typical college student body ranges between 5,000 and 50,000, a sizable population in terms of potential marketing pool. The student association has a pre-existing infrastructure to inexpensively market for a commercial website within this community and typically has a volunteer staff to minimize labor cost and maximize revenue generation for a mid-sized commercial website.

The second essential feature of present invention is that QCs are targeted as mid-sized markets for POG's mid-sized commercial website. QCs are physically located as a community and operate as a single cultural, economical, and/or geographical unit. This makes it more efficient for a POG to market its mid-sized commercial website within the QC. Furthermore, since a POG, by definition, must have a volunteer staff and an established communication channel with its constituents, a POG is an ideal group to market its own mid-sized commercial website within its corresponding QC. An outside group, or a non-POG, cannot match the versatility and cost-efficiency of a POG in effectively advertising its mid-sized commercial website in its corresponding QC.

The third essential feature of present invention is that incentives package provided to a POG to grant a license to share website traffic and website content data involves a CWAWIP. A CWAWIP is an unobvious incentives package in many ways. Providing a cost-free website application, coupled with subsequent cost-free web-hosting is unheard of in the industry, because it costs tens and thousands of dollars to develop a professional commercial website and it takes ever more constant expenses to host a sizable commercial website. Giving away such packages to a large number of POGs at no cost appears financially foolhardy. It is not intuitively obvious to realize that an ASP/WSP can give away CWAWIPs to a large number of POGs and still be commercially successful. It is further intuitively not obvious that receiving and combining all website traffic and website content material from all mid-sized commercial website in a consolidated commercial website (to be run by an ASP/WSP) will more than make up for all expenses an ASP/WSP will incur for provision of CWAWIPs. That is because it costs much less to an ASP/WSP to provide CWAWIPs and receive licenses from POGs to use website traffic and website content data of all mid-sized commercial websites than for the ASP/WSP to acquire equivalent volume of website traffic and website content data through its own efforts.

In addition, the following will summarize all advantages presented by the present invention over other prior methods: One advantage of the present invention is that the adoption of CWAWIP by a POG and the subsequent set-up of a commercial website involves no technical obstacles, because CWAWIP contains the entire website not just a website solutions module.

Another advantage of present invention is in that an ASP/WSP provides a complete, pre-made, customizable and cost-free website application software and web-hosting incentives package (CWAWIP) to POGs. Because a typical POG, such as a student association, often tends to be tightly budgeted and lack the technical know-how to make and run a professional level commercial website (which includes more features than simple HTML codings), such a POG is likely to respond positively to the provision of a technically-advanced CWAWIP at the prospect of immediately owning and operating a professional commercial website. To be sure, a professional commercial site almost always contain website solutions made with programming language often beyond the reach of college students.

Yet another advantage of the prevent invention, and CWAWIP in particular, is that operating a mid-sized commercial website by its very nature will generate future revenues for a POG, and the profitability of the mid-sized commercial website is virtually guaranteed because a POG's marketing and labor cost structure is extremely low. Thus, a student association, for example, stands to gain everything (i.e., free website application software, web-hosting, and resulting revenue generation from its operation) and only stands to lose volunteer manpower.

Yet another advantage of the present system is that per unit cost for the preparation and subsequent distribution of website software for an ASP/WSP is comparatively low because the ASP has to develop a template website application only once. A template website application is easily replicated or altered to suit the needs of different POGs. Furthermore, per unit cost of web-hosting (includes website hosting on ASP/WSP's server and Internet line usage) is also comparatively low, requiring increase in server memory and Internet line bandwidth only when number of mid-sized commercial websites increases or when website content data and website traffic increases.

Yet another advantage of the present invention is that an agreement (i.e., a license) between a POG and a ASP/WSP regarding the sharing of website content data and website traffic of POGs' mid-sized commercial websites is easily achieved, in view of the large consideration given by an ASP/WSP to a POG in the form of cost-free CWAWIP and the prospect of receiving future profits from the operation of mid-sized commercial website. The provision of CWAWIP is specifically conditioned upon a POG's conferring a license to use the website content data and website traffic.

Yet another advantage of the present invention is that it utilizes an unobvious characteristic of a QC that it is also geographically localized as a community. Using QCs as primary markets for mid-sized commercial websites produces the effect of localizing the website. Traditional advertising is thus made more inexpensive and more focused, since a POG only has to advertise within the qualified community, not nationally. All prior attempts to consolidate website traffic have failed in this regard.

Yet another advantage of the present invention is that a QC is defined also to be a single integrated community both economically and culturally, making it more streamlined for a POG to market. QCs, such as college campuses and national social clubs, by their very nature, are a collection of people with common interests. For example, a college student body has students and professors who share academic interest and interest in school life. A local Rotary Club has a membership who share economic and financial interest in the community. In effect, a qualified community acts as a single market with convergent interests.

Yet another advantage in the present invention is that a QC is also sizable. A significant website traffic can come with a given qualified community. For example, a typical student body numbers between 5,000-50,000 in number of students, and such range is preferred over smaller or larger communities. A community smaller than 5,000 is insignificant as an economic unit and a community larger than 50,000 is large enough not to desire the provision of free commercial website package as they themselves can justify making their own commercial website in view of large potential market. Hence, only a handful of QCs covered will quickly give rise to a large number of population.

Yet another advantage of present invention lies in the fact that a POG can serve as an efficient and low-cost distributing point for goods or service transactions. A POG is strategically located in a QC, has a voluntary manpower to lower cost of distribution of goods or services, and has established communication channel with its constituent members. Should a program like “bulk buying” be instituted by a mid-sized or consolidated commercial website, the prices for various goods can be leveraged down significantly for a goods or service because savings on lower shipping cost (because the goods must be delivered only to one destination).

### BRIEF DESCRIPTION OF THE DRAWINGS

FIG. 1 is a diagrammatic view of method of exchanging cost-free website application and web-hosting incentives package for website traffic and website content data between an ASP/WSP and a plurality of potential operator groups (POGs).

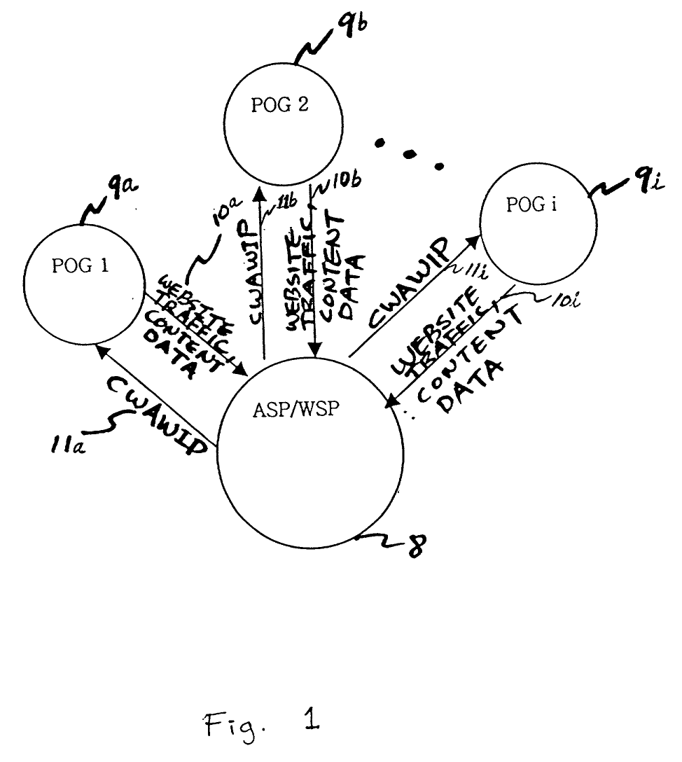

FIG. 2 is a diagrammatic view of website traffic sharing between a plurality of mid-sized commercial websites (MCWs) and a consolidated commercial website (CCW).

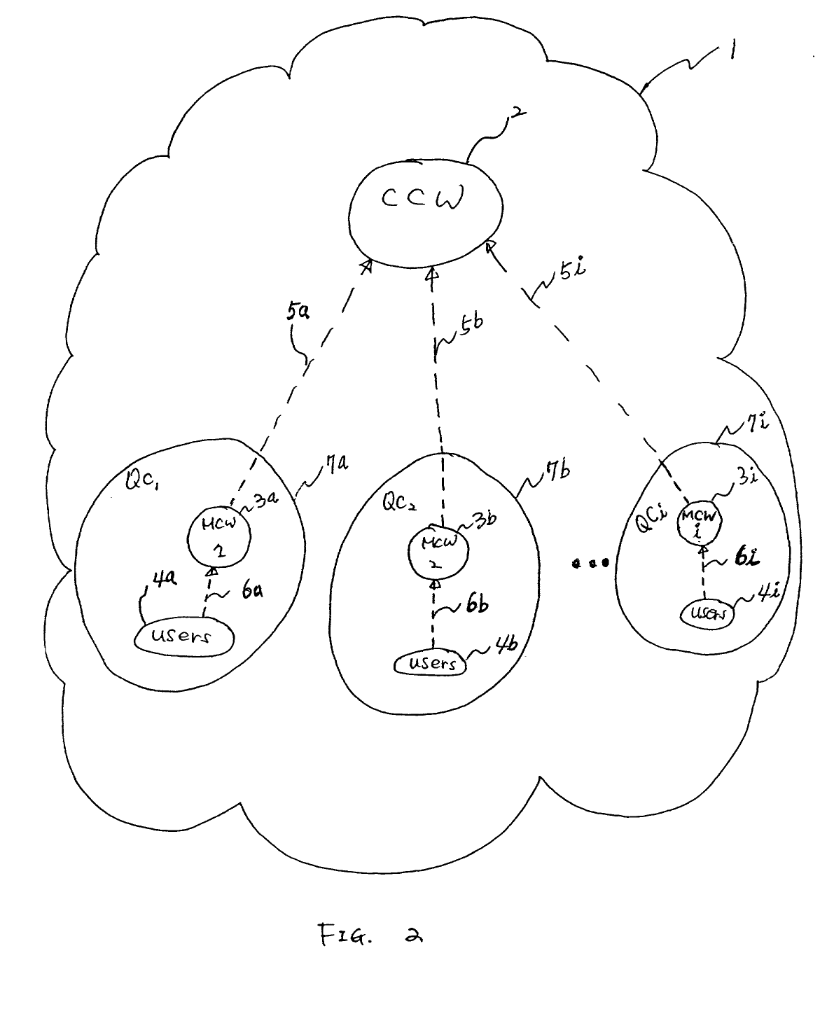

FIG. 3 is a diagrammatic illustration of sharing of website content data information (user info) between a consolidated commercial website database (CCW DB) and a plurality of mid-sized commercial website databases {MCW1 DB, MCW2 DB, . . . MCWi DB}.

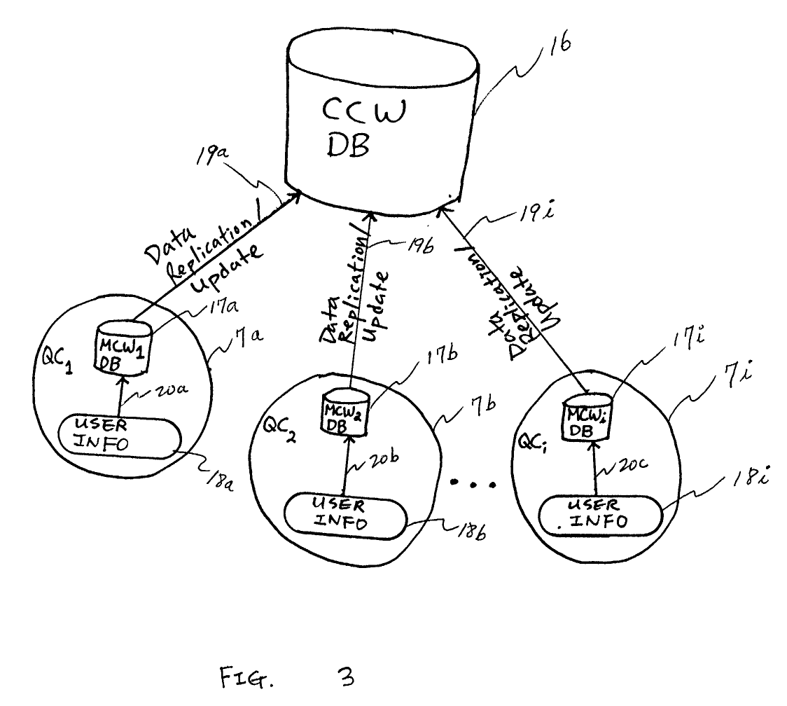

FIG. 4 is a flow chart diagram of the method of acquiring website traffic and website content material from a plurality of mid-sized commercial websites.

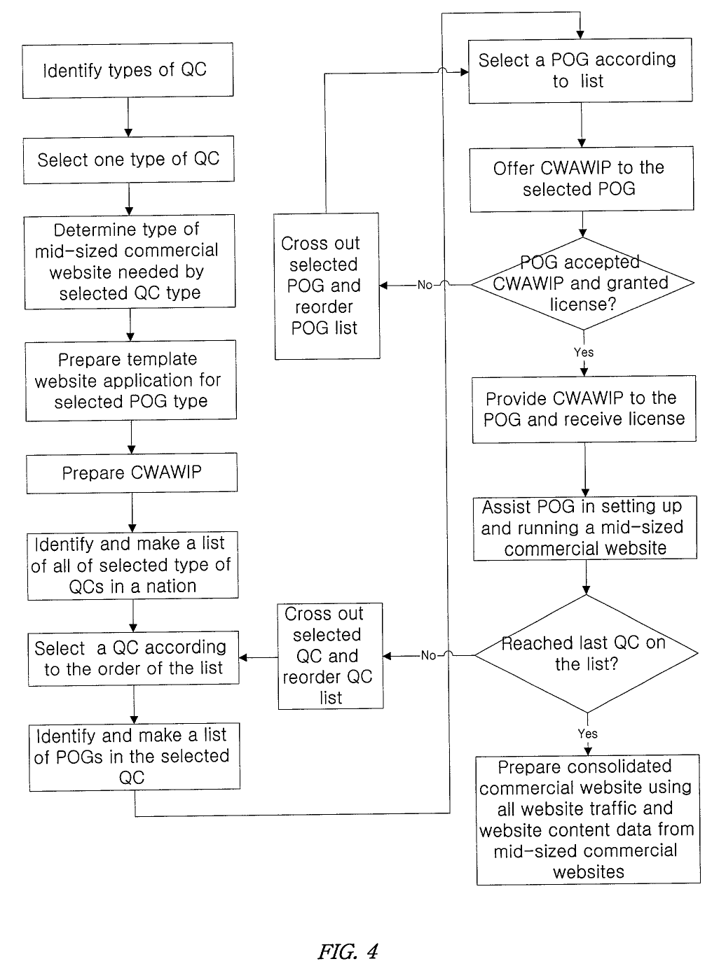

FIG. 5 is a diagrammatic illustration of a plurality of qualified communities, which are physically located in United States being translated into geographically localized communities on the Internet.

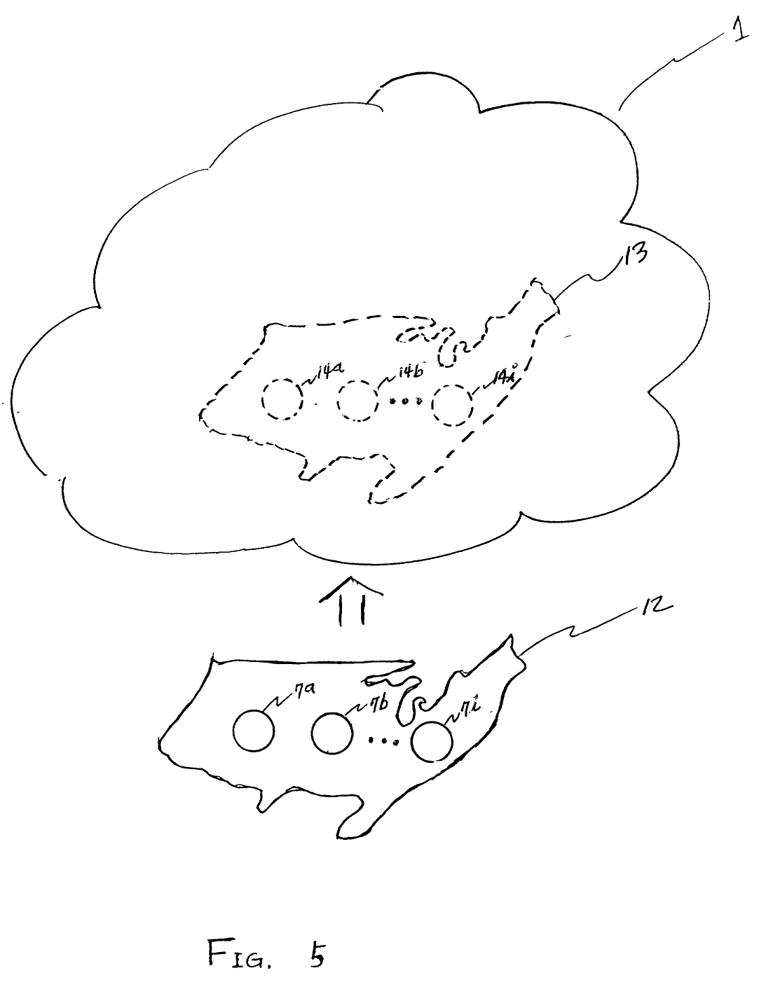

### DETAILED DESCRIPTION OF THE PREFERRED EMBODIMENTS

The present invention is directed to a method of lowering marketing and labor costs of a commercial website connected to other websites over the Internet 1 through offering a cost-free website application and web-hosting incentives package (CWAWIP) 11a, 11b, . . . , 11i to POGs 9a, 9b, . . . , 9i belonging to various qualified communities 7a, 7b, . . . , 7i of a single type in a nation, such as United States 12, in exchange for granting a license to share website traffic and website content data 10a, 10b, . . . , 10i of POG's mid-sized commercial websites 3a, 3b, . . . , 3i. When ASP/WSP 8 receives a plurality of desired licenses from POGs, it then consolidates all mid-sized commercial websites' website traffic 6a, 6b, . . . , 6i and website content data 20a, 20b, . . . , 20c into a consolidated commercial website 2, having a consolidated commercial website database 16 by sharing all mid-sized commercial websites' website traffic as in 5a, 5b, . . . , 5i and performs data replication/update 19a, 19b, . . . , 19i of all mid-sized commercial website databases 17a, 17b, . . . ,17i, each of which processes its own corresponding user information 18a, 18b, . . . ,18i.

I claim:

1. A method to lower labor and marketing cost of a commercial website, comprising steps of:
(a) identifying types of qualified communities in a nation, which ranges between 1,000 and 100,000 in population, has at least one POG, and operates culturally, economically and/or geographically as a single unit;
(b) selecting a type of qualified community from said types of qualified communities;
(c) determining what type of commercial website is needed by said selected type of qualified community;
(d) preparing a template website application in accordance with said determination;
(e) preparing an incentives package comprising of template website application, subsequent web-hosting service, and a permission to potential operator group to keep all revenue generated by operation of a mid-sized commercial website, to be built from and operated with said incentives package;
(f) identifying and making a list of all selected type of qualified communities in a nation;
(g) selecting a qualified community according to the order of the said list;
(h) identifying and making a list of all potential operator groups in said qualified community, which are economically situated to accept a cost-free website application and web-hosting incentives package, staffed with volunteers or low-cost personnel to operate a mid-sized commercial website in the qualified community at little or no labor and marketing cost, and possesses an established communication channel with constituents of qualified community;
(i) selecting a potential operator group according to the order of said list;
(j) offering said incentives package cost-free to said potential operator group, conditioned upon said potential operator group's granting of a license to an ASP/WSP to freely use website traffic and website content data to be generated in said mid-sized commercial website of a potential operator group;
(k) receiving said license, if said potential operator group grants said license; or select another potential operator group by repeating steps (i), (j), and (k), if said potential operator group rejects granting of said license;
(l) providing said incentives package cost free to said potential operator group,
(m) assisting said potential operator group in setting up and running a mid-sized commercial website to be derived from said incentives package;
(n) repeating steps (g), (h), (i), (j), (k), (l) and (m) until last qualified community on said list of all selected type of qualified communities has been offered an incentives package; and
(o) preparing a consolidated commercial website, which uses all website traffic and website content data gathered from all of said mid-sized commercial websites.

2. The method according to claim 1, wherein provision of said incentives package to said potential operator group is further conditioned on a potential operator group's granting of license to use database of said potential operator group's commercial website's registered membership without fee or with a low fee.

3. The method according to claim 1, wherein said incentives package comprises of some combination of monetary and non-monetary incentives other than CWAWIP.

4. The method according to claim 1, wherein said incentives package comprises of CWAWIP and one or more of additional incentive(s).

5. The method according to claim 1, wherein said incentives package is offered not cost-free but at a fee.

6. The method according to claim 1, wherein said license is received at a fee.

7. The method according to claim 1, wherein more than one type of qualified communities are selected in step 1(b).

8. The method according to claim 1, wherein more than one of said template website applications are prepared in step 1(d).
